(19) United States
(12) Patent Application Publication
(10) Pub. No.: US 2014/0279487 A1
(43) Pub. Date: Sep. 18, 2014

(54) SYSTEMS AND METHODS FOR PROVIDING FUNDING CHANGES TO FINANCIAL TRANSACTIONS

(71) Applicant: Thomas Poole, Chantilly, VA (US)

(72) Inventor: Thomas Poole, Chantilly, VA (US)

(73) Assignee: CAPITAL ONE FINANCIAL CORPORATION, McLean, VA (US)

(21) Appl. No.: 14/203,713

(22) Filed: Mar. 11, 2014

Related U.S. Application Data
(60) Provisional application No. 61/786,805, filed on Mar. 15, 2013.

(51) Int. Cl. G06Q 20/22; G06Q 20/10

(52) U.S. Cl. CPC G06Q 20/22; G06Q 20/108
USPC 705/42; 705/39

(57) ABSTRACT

A system is provided for funding changes regarding financial transactions. The system may include one or more memory devices storing software instructions and one or more processors configured to execute the software instructions to, for example, identify a first financial transaction for a first amount involving a first financial account associated with a user, and determine a second financial account associated with the user that can be used to fund the first financial transaction. The one or more processors may also be configured to provide a funding type change option that identifies the second financial account as an alternate financial account for funding the first financial transaction, receive a funding type change indication to change the funding type of the first financial transaction from the first financial account to the second financial account, and process the funding type change indication.

### PRIORITY CLAIM

This application claims priority under 35 U.S.C. §119 to U.S. Provisional Application No. 61/786,805, filed on Mar. 15, 2013, which is expressly incorporated herein by reference in its entirety.

### TECHNICAL FIELD

The disclosed embodiments generally relate to systems and methods for managing financial transactions, and more particularly, systems and methods for providing funding changes to financial transactions.

### BACKGROUND

Consumers sometimes question decisions regarding purchases of goods and services after they occur. For example, a consumer who purchases a product with a credit card account may question whether they actually wanted to use the credit card to make the purchase. For instance, the consumer may have rather used funds from a debit account or a different credit card account to pay for the purchased product. Similarly, a consumer may decide after a recent purchase made with a debit account that the purchase should have been funded through other accounts, such as an installment loan or credit card account. Typically, a consumer has limited options in changing the way a purchase is funded after financial transaction is complete.

### SUMMARY

The disclosed embodiments include systems and methods that enable a user to easily change the funding type used for purchases made with financial accounts, such as credit card accounts or debit accounts.

In certain aspects, the disclosed embodiments may allow a user to select one or more alternate financial accounts to fund a previously performed purchase transaction using another financial account. The disclosed embodiments may provide options to the user via one or more interfaces that enable the user to view one or more previous transactions, the amount of those transactions, and the source accounts used for the transactions. The disclosed embodiments may provide mechanisms that allow the user to select an alternate financial account for funding selected one or more of the previous transactions. Based on the user selections, the disclosed embodiments may process the financial accounts such that, for example, the alternate account may be charged the amount of the selected transaction(s) and to credit the source account originally used to make the transactions.

For example, the disclosed embodiments include a system for providing funding changes regarding financial transactions. The system may include one or more memory devices storing software instructions and one or more processors configured to execute the software instructions to, for example, identify a first financial transaction for a first amount that has previously occurred within a determined period of time, the financial transaction involving a first financial account associated with a user. The one or more processors may also determine a second financial account associated with the user that can be used to fund the first financial transaction for the first amount. The one or more processors may be configured to provide a funding type change option that identifies the second financial account as an alternate financial account for funding the first financial transaction. Also, the one or more processors may receive a funding type change indication to change the funding type of the first financial transaction from the first financial account to the second financial account, and process the funding type change indication such that the first amount is applied to the second financial account and the first amount is credited to the first financial account.

The disclosed embodiments may also include a system for providing funding changes to financial transactions, including one or more memory devices storing software instructions and one or more processors configured to execute the software instructions to, for example, identify a first financial transaction for a first amount and a second financial transaction for a second amount that have previously occurred within a determined period of time, the first financial transaction involving a first financial account associated with a user and the second financial transaction involving one of the first financial account or a second financial account associated with the user. The one or more processors may also determine an alternate financial account associated with the user that can be used to fund the first financial transaction for the first amount and the second financial transaction for the second amount. The processor(s) may also provide a funding type change option that identifies the alternate financial account for funding the first financial transaction and the second financial transaction. Further, the one or more processors may receive a funding type change indication to change the funding type of the first financial transaction from the first financial account to the alternate financial account and to change the funding type of the second financial transaction from the second financial account to the alternate financial account, and process the funding type change indication such that the first amount is applied to the alternate financial account and the first amount is credited to the first financial account and the second financial account.

The disclosed embodiments may also include a computer-implemented method for providing funding changes regarding financial transactions. The method may include identifying, by one or more processors, a first financial transaction for a first amount that has previously occurred within a determined period of time, the financial transaction involving a first financial account associated with a user. The method may also include determining, by one or more processors, a second financial account associated with the user that can be used to fund the first financial transaction for the first amount. Further, the method may include providing, by one or more processors, a funding type change option that identifies the second financial account as an alternate financial account for funding the first financial transaction. Also, the method may include receiving, by one or more processors, a funding type change indication to change the funding type of the first financial transaction from the first financial account to the second financial account, and processing, by one or more processors, the funding type change indication such that the first amount is applied to the second financial account and the first amount is credited to the first financial account.

The disclosed embodiments may also include a computer-implemented method for providing funding changes to financial transactions. The method may include identifying, by one or more processors, a first financial transaction for a first amount and a second financial transaction for a second amount that have previously occurred within a determined period of time, the first financial transaction involving a first financial account associated with a user and the second financial transaction involving one of the first financial account or a second financial account associated with the user. The method may also include determining, by one or more processors, an alternate financial account associated with the user that can be used to fund the first financial transaction for the first amount and the second financial transaction for the second amount. Also, the method may include providing, by one or more processors, a funding type change option that identifies the alternate financial account for funding the first financial transaction and the second financial transaction. Further, the method may include receiving, by one or more processors, a funding type change indication to change the funding type of the first financial transaction from the first financial account to the alternate financial account and to change the funding type of the second financial transaction from the second financial account to the alternate financial account, and processing, by one or more processors, the funding type change indication such that the first amount is applied to the alternate financial account and the first amount is credited to the first financial account and the second financial account.

Although disclosed embodiments are discussed primarily in the context of mobile devices and software instructions that are executed by mobile devices, other implementations are contemplated. For example, disclosed embodiments may include software instructions that are executed by a computing system, such as a desktop computer, a laptop, etc. Moreover, the configuration and architecture, etc. of the computing systems, mobile or non-mobile, are not limiting to the disclosed embodiments. Systems or components that execute software instructions to perform one or more operations consistent with the disclosed embodiments and/or store information generated and/or used by the disclosed embodiments, may be particularly configured to perform the one or more particular operations consistent with the disclosed embodiments.

It is to be understood that both the foregoing general description and the following detailed description are exemplary and explanatory only and are not restrictive of the disclosed embodiments, as claimed.

The accompanying drawings, which are incorporated in and constitute a part of this specification, illustrate disclosed embodiments and, together with the description, serve to explain the disclosed embodiments.

### BRIEF DESCRIPTION OF THE DRAWINGS

FIG. 1 illustrates an exemplary system consistent with disclosed embodiments.

FIG. 2 is a block diagram of an exemplary financial service provider computing system, consistent with disclosed embodiments.

FIG. 3 is a block diagram of an exemplary client computing system, consistent with disclosed embodiments.

FIG. 4 is a flow chart of an exemplary post transaction modification process, consistent with certain disclosed embodiments.

FIG. 5 is a block diagram of an exemplary interface, consistent with certain disclosed embodiments.

FIG. 6 is a block diagram of another exemplary interface, consistent with certain disclosed embodiments.

FIG. 7 is a block diagram of exemplary interface relationships associated with post transaction funding modification processes consistent with certain disclosed embodiments.

FIG. 8 is another block diagram of exemplary interface relationships associated with post transaction funding modification processes consistent with certain disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

FIG. 1 is a diagram illustrating an exemplary system 100 for performing one or more operations consistent with the disclosed embodiments. In one embodiment, system 100 may include a financial service provider 110, client 120, merchant 150, and network 140. The components and arrangement of the components included in system 100 may vary. Thus, system 100 may further include other components that perform or assist in the performance of one or more processes consistent with the disclosed embodiments.

Financial service provider 110 may be an entity that provides financial services. For example, financial service provider 110 may be a bank, credit card issuer, or other type of financial service entity that offers, issues, generates, provides, manages, and/or maintains financial service accounts for one or more users. Financial service accounts may include, for example, credit card accounts, checking accounts, savings accounts, reward accounts, loan accounts (e.g., general (e.g., general purpose use) and specific (e.g., automobile, home improvement, mortgage, etc.)), lines of credit, promotional financing accounts, long term financing accounts, transactional credit accounts, installment loan accounts, and any other types of financial service account known to those skilled in the art. Financial service accounts may be associated with electronic accounts, such as a digital wallet or similar account that may be used to perform electronic transactions, such as purchasing goods and/or services online.

Financial service accounts may also be associated with one or more financial account products, such as physical financial service account cards (e.g., a plastic card or similar type of card product) that a user may carry on their person and use to perform financial service transactions, such as purchasing goods and/or services at a point of sale (POS) terminal. Financial account products may also include electronic type of account products, such as a mini card, or other type of product that may be configured to work with a computing system (e.g., mobile device) to operate like a physical financial account card. Financial service provider 110 may include infrastructure and components that are configured to generate and provide financial service accounts and financial account products (e.g., physical credit cards, check cards, mini cards, digital wallet accounts, etc.). Moreover, as explained, the disclosed embodiments are not limited to financial service accounts or financial service providers. That is, financial service provider 110 may, where other types of accounts or products are implemented, represent an entity that provides other types of accounts or products that may be configured, activated, and/or controlled in a manner consistent with the disclosed embodiments. One of ordinary skill in the art would understand that in such implementations, the operations of financial service provider 110 (and its components) as described herein may vary based on the type of entity and the type of accounts or products implemented by the disclosed embodiments.

In one embodiment, financial service provider 110 may include one or more computing systems that are configured to execute software instructions stored on one or more memory devices to perform one or more operations consistent with the disclosed embodiments. In one embodiment, financial service provider 110 may include server 111. Server 111 may be one or more computing devices configured to execute software instructions stored in memory to perform one or more operations consistent with the disclosed embodiments.

For example, server 111 may include one or more memory device(s) storing data and software instructions and one or more processor(s) configured to use the data and execute the software instructions to perform server-based functions and operations known to those skilled in the art and related to the function and operations of the type of businesses performed by financial service provider 110 (or other type of entity component 110 may represent). Moreover, in certain embodiments, server 111 may be configured to execute software instructions that interact with software program(s) stored and executed by client 120, such as a mobile application that is executed on a mobile device.

Server 111 may be a general purpose computer, a mainframe computer, or any combination of these components. In certain embodiments, server 111 (or a system including server 111) may be configured as a particular apparatus, system, and the like based on the storage, execution, and/or implementation of the software instructions that perform one or more operations consistent with the disclosed embodiments. Server 111 may be standalone, or it may be part of a subsystem, which may be part of a larger system. For example, server 111 may represent distributed servers that are remotely located and communicate over a network (e.g., network 140) or a dedicated network, such as a LAN, for financial service provider 110.

Server 111 may include or may connect to one or more storage devices configured to store data and/or software instructions used by one or more processors of server 111 to perform operations consistent with disclosed embodiments. For example, server 111 may include memory configured to store one or more software programs that performs several functions when executed by a processor. The disclosed embodiments are not limited to separate programs or computers configured to perform dedicated tasks. For example, server 111 may include memory that stores a single program or multiple programs. Additionally, server 111 may execute one or more programs located remotely from server 111. For example, server 111 may access one or more remote programs stored in memory included with a remote component that, when executed, perform operations consistent with the disclosed embodiments. In certain aspects, server 111 may include web server software that generates, maintains, and provides web site(s) that are accessible over network 140. In other aspects, financial server provider 110 may connect separate web server(s) or similar computing devices that generate, maintain, and provide web site(s) for financial service provider 110.

Network 140 may be any type of network configured to provide communications between components of system 100. For example, network 100 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s), such as the exemplary links between financial service provider 110 and merchant 150.

Client 120 may be one or more computing devices that are configured to execute software instructions for performing one or more operations consistent with the disclosed embodiments. Client 120 may be a desktop computer, a laptop, a server, a mobile device (e.g., tablet, smart phone, etc.), and/or any other type of computing device. Client 120 may include one or more processors configured to execute software instructions stored in memory, such as memory included in client 120. Client 120 may include software that when executed by one or more processors performs known Internet-related communications and content display processes. For instance, client 120 may execute browser software that generates and displays interfaces including content on a display device included in, or connected to, client 120. The disclosed embodiments are not limited to any particular configuration of client 120. For instance, client 120 may be a mobile device that stores and executes mobile applications that provide financial service related functions offered by financial service provider 110 and/or merchant 150, such as a mobile banking application for controlling, configuring, and viewing information relating to financial accounts, etc. In certain embodiments, client 120 may be configured as a particular apparatus, system, and the like based on the storage, execution, and/or implementation of the software instructions that perform one or more operations consistent with the disclosed embodiments.

In one embodiment, a user 101 may provide input to client 120 that is used by software executed by client 120 to perform one or more operations consistent with the disclosed embodiments. In one aspect, user 101 may be a customer or a potential customer of financial service provider 110. For instance, financial service provider 110 may generate and maintain a financial service account (e.g., credit card account, a line of credit, etc.) for user 101 such that user 101 may use the account to purchase goods and/or services online or at brick and mortar locations associated with a merchant, such as merchant 150. In other embodiments, user 101 may be a potential customer of financial service provider 110 or may not be affiliated with financial service provider 110 from the user's perspective and/or financial service provider 110's perspective.

Merchant 150 may be an entity that provides goods and/or services for purchase by consumers (e.g., individuals, businesses, etc.). While FIG. 1 shows one merchant 150, in system 100, the disclosed embodiments may be implemented in a system involving multiple and different merchants (e.g., a restaurant merchant and a grocery store merchant, and a retail store merchant, etc.). Merchant 150 may include brick and mortar location(s) that a consumer (e.g., user 101) may physically visit and purchase goods and services. Such physical locations may include computing devices that perform financial service transactions with consumers (e.g., POS terminal(s), kiosks, etc.). They may also include back and/or front-end computing components that store data and execute software instructions to perform operations consistent with disclosed embodiments, such as computers that are operated by employees of merchant 150 (e.g., back office systems, etc.). In certain embodiments, merchant 150 may also include one or more merchants that provide electronic shopping mechanisms, such as a website or similar online location that consumers may access using a computer (e.g., client 120) through browser software or similar software.

In one embodiment, merchant 150 may include server 151. Server 151 may be one or more computing devices configured to execute software instructions stored in memory to perform one or more processes consistent with the disclosed embodiments. For example, server 151 may include one or more memory device(s) storing data and software instructions and one or more processor(s) configured to use the data and execute the software instructions to perform server-based functions and operations known to those skilled in the art. Server 151 may be a general purpose computer, a mainframe computer, or any combination of these components. In certain embodiments, server 151 (or a system including server 111) may be configured as a particular apparatus, system, and the like based on the storage, execution, and/or implementation of the software instructions that perform one or more operations consistent with the disclosed embodiments. Server 151 may be standalone, or it may be part of a subsystem, which may be part of a larger system. For example, server 151 may represent distributed servers that are remotely located and communicate over a network (e.g., network 140) or a dedicated network, such as a LAN, for merchant 150.

In certain aspects, server 151 may include web server software that generates, maintains, and provides web site(s) for a respective merchant 150 that is accessible over network 140. In other aspects, merchant 150 may connect separate to web server(s) or similar computing devices that generate, maintain, and provide web site(s) for merchant 150. For example, merchant 150 may use web server(s) that provide a web site specific to merchant 150, and allows user 101 to access, view, and purchase goods and/or services from merchant 150.

FIG. 2 shows an exemplary computing system including server 111 for financial service provider 110, consistent with certain disclosed embodiments. In one embodiment, server 111 may include one or more processors 221, one or more memories 223, and one or more input/output (I/O) devices 222. Alternatively, server 111 may take the form of a general purpose computer, a mainframe computer, or any combination of these components. In certain embodiments, server 111 (or a system including server 111) may be configured as a particular apparatus, system, and the like based on the storage, execution, and/or implementation of the software instructions that perform one or more operations consistent with the disclosed embodiments. Server 111 may be standalone, or it may be part of a subsystem, which may be part of a larger system.

Processor 221 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 111.

Memory 223 may include one or more storage devices configured to store instructions used by processor 221 to perform functions related to disclosed embodiments. For example, memory 223 may be configured with one or more software instructions, such as program(s) 224 that may perform one or more operations when executed by processor(s) 221. The disclosed embodiments are not limited to separate programs or computers configured to perform dedicated tasks. For example, memory 223 may include a single program 224 that performs the functions of the server 211, or program 224 could comprise multiple programs. Additionally, processor 221 may execute one or more programs located remotely from server 211. For example, financial service provider 110, via server 111, may access one or more remote programs that, when executed, perform functions related to certain disclosed embodiments.

Memory 223 may also store data 225 that may reflect any type of information in any format that the system may use to perform operations consistent with the disclosed embodiments.

I/O devices 222 may be one or more device that is configured to allow data to be received and/or transmitted by server 111. I/O devices 222 may include one or more digital and/or analog communication devices that allow server 111 to communicate with other machines and devices, such as other components of systems 100.

Server 111 may also be communicatively connected to one or more database(s) 227. Server 111 may be communicatively connected to database(s) 227 through network 140. Database 227 may include one or more memory devices that store information and are accessed and/or managed through server 111. By way of example, database(s) 227 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, server 111 as exemplified in FIG. 2 may include database 227. Alternatively, database 227 may be located remotely from the server 111. Database 227 may include computing components (e.g., database management system, database server, etc.) configured to receive and process requests for data stored in memory devices of database(s) 227 and to provide data from database 227.

FIG. 3 shows an exemplary client 120 consistent with certain disclosed embodiments. In one embodiment, client 120 may include one or more processors 321, one or more memories 323, and one or more input/output (I/O) devices 322. In one embodiment, client 120 may take the form of a general purpose computer, a mainframe computer, or any combination of these components. In certain embodiments, client 120 (or a system including client 120) may be configured as a particular apparatus, system, and the like based on the storage, execution, and/or implementation of the software instructions that perform one or more operations consistent with the disclosed embodiments. Client 120 may be standalone, or it may be part of a subsystem, which may be part of a larger system.

Processor 321 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in client 120.

Memory 323 may include one or more storage devices configured to store instructions used by processor 321 to perform functions related to the disclosed embodiments. For example, memory 323 may be configured with one or more software instructions, such as program(s) 324 that may perform one or more operations when executed by processor 321. The disclosed embodiments are not limited to separate programs or computers configured to perform dedicated tasks. For example, memory 323 may include a single program 324 that performs the functions of client 120, or program 324 could comprise multiple programs. Additionally, processor(s) 321 may execute one or more programs located remotely from client 120. For example, client 120, may access one or more remote programs that, when executed, perform functions related to certain disclosed embodiments.

Memory 323 may also store data 325 that may reflect any type of information in any format that the system may use to perform operations consistent with the disclosed embodiments.

I/O devices 322 may be one or more device that is configured to allow data to be received and/or transmitted by server 311. I/O devices 322 may include one or more digital and/or analog communication devices that allow server 311 to communicate with other machines and devices, such as other components of system 100.

In certain embodiments, memory 323 may store a mobile banking application 325. Mobile banking application may be one or more programs or software instructions that, when executed by processor(s) 321, perform one or more mobile banking operations. For example, mobile banking application 325 may be a mobile application that is stored in a mobile device (e.g., client 120) that performs operations and generates interface(s) that are displayed on a display device of client 120. The interface(s) may be configured to present information and provide request(s) that elicit input from user 101. Client 120 may be configured with known input hardware and software components that accept input from user 101 through known mobile device mechanisms, such as touch screen technologies, voice input, keypad entry, etc. Mobile banking application 325 may be configured to use information associated with the user 101 input to generate information, analyze and determine condition(s), generate results based on those condition(s), and provide data and interface(s) including the data. In certain aspects, mobile banking application 325 may be configured to perform one or more processes consistent with the disclosed embodiments, such as, for example, providing interfaces with options to allow a user to change the funding type of recent purchase transactions involving one or more financial accounts provided by financial service provider 110.

FIG. 4 shows a flowchart of an exemplary post transaction modification process, consistent with disclosed embodiments. In one embodiment, one or more process steps of FIG. 4 may be performed by client 120. In one aspect, client 120 may execute mobile banking applications 325 to perform one or more steps of FIG. 4. In other embodiments, client 120 may execute other software instructions stored in memory (e.g., memory 323) to perform one or more steps of FIG. 4. In yet other embodiments, server 111 may execute software instructions to perform one or more steps of FIG. 4.

The post transaction modification process may involve collecting transaction data regarding transactions involving one or more financial accounts held by user 101 and provided by financial service provider 110 (step 410). For example, in one embodiment, server 111 may access transaction data associated with financial account(s) associated with user 101 stored in memory. Sever 111 may use known access mechanisms for searching and collecting transaction data, such as database queries and search mechanisms. Server 111 may collect transaction data that occurred within a certain period of time (e.g., collect transaction data relating to user 101's financial account(s) that occurred within the past N days, or within the past X hours, etc.). The transaction data may include information relating to one or more financial transactions involving one or more financial accounts held by user 101, such as transaction identification information, merchant identification data, time stamp information, amount of transaction, the type of transaction (e.g., purchases, deposits, withdrawals, etc.), item description data (e.g., data describing a product or service involved in the transaction, such as a summary of what was purchased), and other information relating to transactions involving financial account(s) of user 101. In certain embodiments, collecting transaction data may be limited to certain types of financial accounts, such as only accounts that may be used for purchase transactions (e.g., credit accounts, loan accounts, debit accounts). In other embodiments, collecting transaction data may be limited to collecting transaction data regarding certain types of transactions, such as purchase transactions. One skilled in the art would understand that known data searching and analysis processes may be implemented to parse transaction data relating to financial accounts of user 101 in this manner.

In certain embodiments, step 410 may involve process(es) performed by client 120. For example, client 120 may request transaction data regarding transactions involving one or more financial accounts of user 101 from server 111 or another source of such information. In response, server 111 may provide the requested transaction data to client 120 for processing in accordance with the disclosed embodiments. For instance, client 120 may execute a financial management application or a mobile banking application that, in response to request(s) from user 101, may generate and send a request to server 111 to collect the transaction data in accordance with the disclosed embodiments.

The disclosed embodiments may also include processes that collect transaction data for transactions that occur in real-time. That is, in one embodiment, server 111 or client 120 may be configured to execute software process that collect transaction data for a transaction that has just occurred or is in the process of being analyzed by software processes during authorization of a pending transaction involving user 101 and a merchant (e.g., merchant 150). For example, in scenarios where client 120 may have been involved in a financial transaction, such as the use of a mobile banking application or in online purchase transactions, client 120 may be configured to store transaction data obtained during the transaction session involving client 120. Client 120 may collect the stored transaction data for performing one or more operations associated with the post transaction modification process.

In certain embodiments, the post transaction modification process may include identifying transactions that occurred within a determined period of time (e.g., step 420). For example, server 111 or client 120 may be configured to parse the collected transaction data in step 410 to identify transactions that occurred within a certain period of time (e.g., within X hours, within Y days, within Z minutes, within M weeks, etc.). In embodiments where step 410 involved processes that may have already filtered transactions and collected transaction data that occurred with the determined period of time, step 420 may be skipped.

In certain aspects, the post transaction modification process may include generating one or more funding change option(s) for identified transactions (step 430). For instance, server 111 or client 120 may determined for each identified transaction that occurred within the determined period of time, one or more other financial accounts held by user 101 that was not used for the transaction, and one or more other financial payment options that user 101 may be eligible to receive to pay for the identified transaction. For example, server 111 or client 120 may determine that user 101 holds two credit card accounts, a debit account, and has a line of credit, each provided by financial service provider 110. In addition, user 101 may be preapproved by financial service provider 110 for a loan account, such a home equity loan, etc. Server 111 or client 120 may determine which of the user 101's financial accounts was used in the identified transaction under analysis (e.g., a first credit card account). Server 111 or client 120 may determine whether any of the other financial accounts not involved in the identified transaction under analysis can be used to fund the identified transaction. For example, server 111 or client 120 may determine that the user 101's second credit card account does not have an available balance sufficient to pay for the amount relating to the identified transaction.

For exemplary purposes. FIG. 5 shows a block diagram of exemplary purchase transactions 510 and available financial accounts 520 associated with user 101. In this example, server 111 or client 120 may determine alternate funding accounts that may be used to fund each of the identified transactions 510. For instance, server 111 or client 120 may determine that the transaction on Date 1 involving credit card account 1 may be alternatively funded by user 101's debit card account 1, line of credit account, and the preapproved account (e.g., a preapproved loan, etc.), each which has an available balance that can cover the $500 purchase amount for the Date 1 transaction involving credit card account 1. Similarly, server 111 or client 120 may determine that credit accounts 1 and 2, the line of credit, and preapproved account, may be alternate accounts for funding the transaction that occurred on Date 2 involving user 101's debit card account 1.

Thus, in certain embodiments, server 111 or client 120 may execute software instructions that determine alternate sources of funding each of the transactions identified in steps 410 or 420. Based on that information, server 111 or client 120 may generate funding change option(s) for user 101 (step 430) and generate and provide one or more interfaces for displaying the funding change options (step 440). For example, the disclosed embodiments may generate an interface that lists one or more the identified transactions (e.g., the transactions that have occurred within a determined period of time) and provides an option for user 101 to select to initiate a funding change for a designated transaction. For example, FIG. 6 shows an exemplary interface 610 that may include a listing of identified transactions and an option for user 101 to select to changing the funding type for each transaction. Interface 610 is exemplary, as is the arrangement, configuration, and type of data provided in exemplary interface 610. The disclosed embodiments may generate and provide interface(s) that include additional, less, or different information and formats without departing from the functionality of the disclosed embodiments.

In certain aspects, user 101 may select an option to change the funding type for a designated transaction. In response, server 111 or client 120 may generate and provide one or more interfaces that provide the funding change options available for funding a designated transaction. For example, FIG. 7 shows an exemplary interface 710 that may be provided in response to a selection of an identified transaction, consistent with disclosed embodiments. In this example, interface 710 may be provided in response to change the funding type of a first listed transaction involving user 101's credit card account. Client 120 or server 111 may provide an interface that includes a listing of available funding change options 720 that user 101 may be able to select to fund the selected transaction. In certain aspects, client 120 or server 111 may generate the funding change options 720 based on the information determined in step 430 of FIG. 4. In this example, interface 710 may include options for funding the selected transaction using user 101's banking account (e.g., a debit account), an installment loan (which may be preapproved), a home equity lending account, or with reward points. Other funding options may be provided based on the funding change options determined in step 430 of FIG. 4.

As another example, FIG. 8 shows an exemplary interface 810 that may be provided in response to a selection of another identified transaction, consistent with disclosed embodiments. In this example, interface 810 may be provided in response to change the funding type of a second listed transaction involving user 101's debit card account. Client 120 or server 111 may provide an interface that includes a listing of available funding change options 820 that user 101 may be able to select to fund the selected transaction. In certain aspects, client 120 or server 111 may generate the funding change options 820 based on the information determined in step 430 of FIG. 4. In this example, interface 810 may include options for funding the selected transaction using user 101's credit card account, an installment loan (which may be preapproved), a home equity lending account, or with reward points. Other funding options may be provided based on the funding change options determined in step 430 of FIG. 4.

Interfaces 810 and 820 are exemplary, as is the arrangement, configuration, and type of data provided in exemplary interfaces 810 and 820. The disclosed embodiments may generate and provide interface(s) that include additional, less, or different information and formats without departing from the functionality of the disclosed embodiments. For example, client 120 or server 111 may provide interface(s) that provide options for user 101 to select one or more transactions for funding changes. For instance, the disclosed embodiments may enable user 101 to select multiple transactions (e.g., all transactions involving a credit card account, or two of three transactions involving a debit account, etc.) for funding changes for the selected group. Further, the disclosed embodiments may provide interface(s) that enable user 101 to select an alternate financial account to fund the selected group of transactions (e.g., user may select a debit account to fund all credit card account transactions in the selected group of transactions).

In certain aspects, client 120 or server 111 may receive a funding change selection for one or more of the identified transactions that may be provided to user 101 (step 450). For example, as described above, the disclosed embodiments may provide interfaces that enable user 101 to select one or more transactions for changing the funding type, and to select the alternate financial account to fund the selected one or more transactions. Server 111 or client 120 may process user 101's funding change selections in accordance with the disclosed embodiments (e.g., step 460).

In certain embodiments, client 120 or server 111 may process a funding change selection based on the type of alternate account selected to fund an identified transaction. For example, in one aspect, client 120 or server 111 may execute software processes that charges or applies a transaction amount to a selected alternate funding account and also credits the original account used in the identified transactions. For instance, referring to FIG. 5, in response to input from user 101 reflecting a selection of debit card account 1 to fund the first listed transaction of “Date 1” in place of the credit card account 1, client 120 or server 111 may be configured to charge the debit card account 1 the $500 amount for the Date 1 transaction, and credit the credit card account 1 the $500 amount for the transaction. Thus, in this example, after processing, the available balance for credit card account 1 may be $3500 (e.g., $3000 available balance+$500 transaction amount credit) and the available balance for the debit card account 1 may be $500 (e.g., $1000 available balance−$500 transaction amount charge).

In other examples, the disclosed embodiments may allow user 101 to select alternate funding using reward point accounts associated with financial service provider 110 (or another entity). For example, as exemplary shown in FIGS. 7 and 8, server 111 or client 120 may provide an option for user 101 to change the funding of a transaction (e.g., the first or second transactions listed in FIGS. 7 and 8) to a rewards point account. If selected, server 111 or client 120 may process the selected funding change request to determine how many points to subtract from the reward point account to cover the transaction amount of the selected transaction. In certain aspects, server 111 or client 120 may determine prior to presenting a reward points funding change type whether the user 101's reward points account has sufficient points to cover the transaction amount, or whether the type of item or service involved in a transaction is covered by user 101's reward points program, etc. (e.g., during step 430 of FIG. 4).

The disclosed embodiments may generate and provide an indication that the fund change request has been processed. In one embodiment, server 111 or client 120 may generate and provide one or more interfaces that provide the indication for display to user 101. In other embodiments, server 111 or client 120 may provide a message to user 101 using other communication mechanisms, such as email, text message, alert on client 120, voice message through automated messaging technologies, etc.

The disclosed embodiments may also be configured to provide fund change processes in real-time. For example, the disclosed embodiments may be configured to determine when user 101 is involved or has completed a financial transaction involving a financial account provided by financial service provider 110. For instance, server 111 or client 120 may be able to detect when user 101 is involved in a purchase transaction with merchant 160 involving a credit card account provided by financial service provider 110. During the purchase transaction session, user 101 may present a physical financial card to merchant 160 for charging the amount of the purchase. Alternatively, user 101 may use mobile banking application 325 on a mobile client 120 to perform wireless electronic payment using a financial account. Server 111 or client 120 may collect transaction data during the transaction session that provides the amount of the transaction, information regarding items purchases, the time and date, and identifies the financial account used for the transaction, among other information. For instance, during financial account authorization while the purchase transaction is taking place, server 111 may collect transaction information regarding the session. As another example, if client 120 is used to perform a mobile electronic payment through a mobile banking application or similar software, client 120 may collect and store transaction information relating to the purchase transaction.

Based on the collected transaction information, server 111 or client 120 may be configured to generate and provide a notification to user 101 via client 120, for example, that informs user 101 that the purchase transaction that has occurred with merchant 160 may be funded with an alternate financial account (e.g., a fund change notification message). In response, user 101 may initiate software using client 120 to perform one or more of the fund change processes consistent with disclosed embodiments, such as processes included in the post transaction modification process of FIG. 4. Thus, in certain examples, a user 101 who has purchased a product using a first financial account may receive a notification in a time frame near when the user is still in the merchant location associated with the purchase, or soon after leaving the location. Alternatively, the capabilities and options available to user 101 through post transaction modification processes of the disclosed embodiments may be available to user 101 for access and initiation at any time after a financial transaction has occurred.

The disclosed embodiments are not limited to any sequence of steps illustrated in FIG. 4 or disclosed herein. For example, one or more of the steps shown in FIG. 4 may be optional or not performed without departing from the disclosed embodiments. Further, additional process steps may be included in the post transaction modification process without departing from the disclosed embodiments.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

What is claimed is:

1. A system for providing funding changes regarding financial transactions, comprising:
one or more memory devices storing software instructions; and
one or more processors configured to execute the software instructions to:
identify a first financial transaction for a first amount that has previously occurred within a determined period of time, the financial transaction involving a first financial account associated with a user;
determine a second financial account associated with the user that can be used to fund the first financial transaction for the first amount;
provide a funding type change option that identifies the second financial account as an alternate financial account for funding the first financial transaction;
receive a funding type change indication to change the funding type of the first financial transaction from the first financial account to the second financial account; and
process the funding type change indication such that the first amount is applied to the second financial account and the first amount is credited to the first financial account.

2. The system of claim 1, wherein the one or more processors are further configured to:
process the funding type change indication such that the first amount is applied to the second financial account and the first amount is credited to the first financial account by:
providing a notification of the funding type change indication to a server such that the server applies the first amount to the second financial account and credits the first amount to the first financial account.

3. The system of claim 1, wherein the one or more processors are further configured to:
process the funding type change indication such that the first amount is applied to the second financial account and the first amount is credited to the first financial account by:
receiving a notification of the funding type change indication from a client associated with the user,
applying the first amount to the second financial account, and
crediting the first amount to the first financial account.

4. The system of claim 1, wherein the system is a mobile device and the software instructions are associated with a mobile banking application executed by the one or more processors.

5. The system of claim 1, wherein the system is one or more computing systems associated with a financial service provider that provides the first and second financial accounts.

6. The system of claim 1, wherein the first financial account is a credit card account or a debit account.

7. The system of claim 1, wherein the first financial account is a credit card account and the second financial account is a debit account, an installment loan account, a second credit card account different from the first financial account, a home equity financial account, or a reward points account.

8. The system of claim 1, wherein the first financial account is a debit card account and the second financial account is a credit card account, an installment loan account, a home equity financial account, or a reward points account.

9. The system of claim 1, wherein the one or more processors are further configured to:
provide the change fund type option that identifies the second financial account and a third financial account as alternate financial accounts for funding the first financial transaction.

10. A system for providing funding changes to financial transactions, comprising:
one or more memory devices storing software instructions; and
one or more processors configured to execute the software instructions to:
identify a first financial transaction for a first amount and a second financial transaction for a second amount that have previously occurred within a determined period of time, the first financial transaction involving a first financial account associated with a user and the second financial transaction involving one of the first financial account or a second financial account associated with the user;
determine an alternate financial account associated with the user that can be used to fund the first financial transaction for the first amount and the second financial transaction for the second amount;
provide a funding type change option that identifies the alternate financial account for funding the first financial transaction and the second financial transaction;
receive a funding type change indication to change the funding type of the first financial transaction from the first financial account to the alternate financial account and to change the funding type of the second financial transaction from the second financial account to the alternate financial account; and
process the funding type change indication such that the first amount is applied to the alternate financial account and the first amount is credited to the first financial account and the second financial account.

11. The system of claim 10, wherein the one or more processors are further configured to:
process the funding type change indication such that the first amount is applied to the alternate financial account and the first amount is credited to the first financial account and the second financial account by:
providing a notification of the funding type change indication to a server such that the server applies the first amount to the alternate financial account and credits the first amount to the first financial account and to the second financial account.

12. The system of claim 10, wherein the one or more processors are further configured to:
process the funding type change indication such that the first amount is applied to the alternate financial account and the first amount is credited to the first financial account and the second financial account by:
receiving a notification of the funding type change indication from a client associated with the user,
applying the first amount to the alternate financial account, and
crediting the first amount to the first financial account and to the second financial account.

13. The system of claim 10, wherein the system is a mobile device and the software instructions are associated with a mobile banking application executed by the one or more processors.

14. The system of claim 10, wherein the system is one or more computing systems associated with a financial service provider that provides the first and second financial accounts.

15. A computer-implemented method for providing funding changes regarding financial transactions, comprising:
Identifying, by one or more processors, a first financial transaction for a first amount that has previously occurred within a determined period of time, the financial transaction involving a first financial account associated with a user;
determining, by one or more processors, a second financial account associated with the user that can be used to fund the first financial transaction for the first amount;
providing, by one or more processors, a funding type change option that identifies the second financial account as an alternate financial account for funding the first financial transaction;
receiving, by one or more processors, a funding type change indication to change the funding type of the first financial transaction from the first financial account to the second financial account; and
processing, by one or more processors, the funding type change indication such that the first amount is applied to the second financial account and the first amount is credited to the first financial account.

16. The method of claim 15, wherein processing the funding type change indication such that the first amount is applied to the second financial account and the first amount is credited to the first financial account includes:
providing a notification of the funding type change indication to a server such that the server applies the first amount to the second financial account and credits the first amount to the first financial account.

17. The method of claim 15, wherein processing the funding type change indication such that the first amount is applied to the second financial account and the first amount is credited to the first financial account includes:
receiving a notification of the funding type change indication from a client associated with the user;
applying the first amount to the second financial account; and
crediting the first amount to the first financial account.

18. The method of claim 15, wherein the one or more processors are included in a mobile device that execute a mobile banking application.

19. The method of claim 15, wherein the one or more processors are included in a computing system associated with a financial service provider that provides the first and second financial accounts and the alternate financial account.

20. The method of claim 15, wherein the first financial account is a credit card account or a debit account.

21. The method of claim 15, wherein the first financial account is a credit card account and the second financial account is a debit account, an installment loan account, a second credit card account different from the first financial account, a home equity financial account, or a reward points account.

22. The method of claim 15, wherein the first financial account is a debit card account and the second financial account is a credit card account, an installment loan account, a home equity financial account, or a reward points account.

23. The method of claim 15, further comprising:
providing the change fund type option to the user that identifies the second financial account and a third financial account as alternate financial accounts for funding the first financial transaction.

24. A computer-implemented method for providing funding changes to financial transactions, comprising:
identifying, by one or more processors, a first financial transaction for a first amount and a second financial transaction for a second amount that have previously occurred within a determined period of time, the first financial transaction involving a first financial account associated with a user and the second financial transaction involving one of the first financial account or a second financial account associated with the user;
determining, by one or more processors, an alternate financial account associated with the user that can be used to fund the first financial transaction for the first amount and the second financial transaction for the second amount;
providing, by one or more processors, a funding type change option that identifies the alternate financial account for funding the first financial transaction and the second financial transaction;
receiving, by one or more processors, a funding type change indication to change the funding type of the first financial transaction from the first financial account to the alternate financial account and to change the funding type of the second financial transaction from the second financial account to the alternate financial account; and
processing, by one or more processors, the funding type change indication such that the first amount is applied to the alternate financial account and the first amount is credited to the first financial account and the second financial account.

25. The method of claim 24, wherein processing the funding type change indication such that the first amount is applied to the alternate financial account and the first amount is credited to the first financial account and the second financial account includes:
providing a notification of the funding type change indication to a server such that the server applies the first amount to the alternate financial account and credits the first amount to the first financial account and to the second financial account.

26. The method of claim 24, wherein processing the funding type change indication such that the first amount is applied to the alternate financial account and the first amount is credited to the first financial account and the second financial account includes:
receiving a notification of the funding type change indication from a client associated with the user;
applying the first amount to the alternate financial account; and
crediting the first amount to the first financial account and to the second financial account.

27. The method of claim 24, wherein the one or more processors are included in a mobile device that executes a mobile banking application.

28. The method of claim 24, wherein the one or more processors are included in a computing system associated with a financial service provider that provides the first and second financial accounts and the alternate financial account.
